(19) United States
(12) Patent Application Publication
(10) Pub. No.: US 2019/0270446 A1
(43) Pub. Date: Sep. 5, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Etsuo Watanabe, Wako-shi (JP); Yuki Oshitani, Tokyo (JP); Ryoma Taguchi, Tokyo (JP)

(21) Appl. No.: 16/261,628

(22) Filed: Jan. 30, 2019

(30) Foreign Application Priority Data
Mar. 2, 2018 (JP) 2018-037552

(51) Int. Cl. B60W 30/09; B60W 10/04; B60W 10/20; B60W 10/18

(52) U.S. Cl. CPC B60W 30/09; B60W 10/04; B60W 10/20; B60W 10/18; B60W 2720/106; B60W 2550/30; B60W 2710/18; B60W 2710/20; B60W 2550/10

(57) ABSTRACT

In an automated driving control device (100), a vehicle control device includes a recognition unit (130) that is configured to recognize a peripheral situation of a vehicle and a driving control unit (120, 160) that is configured to automatically perform control of acceleration/deceleration and steering of the vehicle on the basis of the peripheral situation recognized by the recognition unit, in which the recognition unit determines whether or not a traffic participant present in an advancement direction of the vehicle is aware of the presence of the vehicle, and, in a case in which the traffic participant advancing in the same direction as that of the vehicle is recognized in the advancement direction of the vehicle by the recognition unit, and it is determined by the recognition unit that the traffic participant is not aware of the presence of the vehicle, the driving control unit causes the vehicle to run behind the traffic participant and, in a case in which a period of the running behind the traffic participant becomes equal to or longer than a reference, causes the vehicle to run in a predetermined form.

### CROSS-REFERENCE TO RELATED APPLICATION

Priority is claimed on Japanese Patent Application No. 2018-037552, filed Mar. 2, 2018, the content of which is incorporated herein by reference.

### BACKGROUND OF THE INVENTION

### Field of the Invention

The present invention relates to a vehicle control device, a vehicle control method, and a storage medium.

### Description of Related Art

Conventionally, a subject vehicle presence notification device, which is for a vehicle such as an electric vehicle of which the driving sound is extremely small and notifies pedestrians positioned in the periphery of a subject vehicle of the presence of the subject vehicle using a physical sound, is known (for example, Japanese Unexamined Patent Application First Publication No. 2009-67382). In Patent Document 1, a technology for notifying pedestrians of the presence of the subject vehicle by operating a physical sound generating unit for notification using a physical sound having a volume lower than a horn called a load noise generated in accordance with an engine sound (operating sound) and a change in air pressure of tires is disclosed.

### SUMMARY OF THE INVENTION

However, in the conventional technology, driving control for causing traffic participants such as pedestrians to be aware of the presence of a subject vehicle when the subject vehicle runs behind or bypasses the traffic participants is not considered.

The present invention is realized in consideration of such situations, and one object thereof is to provide a vehicle control device, a vehicle control method, and a storage medium capable of more appropriately performing driving control of a subject vehicle in the case of running behind or bypassing traffic participants.

A vehicle control device, a vehicle control method, and a storage medium according to the present invention employ the following configurations.

(1): A vehicle control device according to one aspect of the present invention is a vehicle control device including: a recognition unit that is configured to recognize a peripheral situation of a vehicle; and a driving control unit that is configured to perform control of acceleration/deceleration and steering of the vehicle on the basis of the peripheral situation recognized by the recognition unit, wherein the recognition unit determines whether or not a traffic participant present in an advancement direction of the vehicle is aware of the presence of the vehicle, and in a case in which the traffic participant advancing in the same direction as that of the vehicle is recognized by the recognition unit, and it is determined by the recognition unit that the traffic participant is not aware of the presence of the vehicle, the driving control unit causes the vehicle to run behind the traffic participant, and in a case in which a period of running behind the traffic participant becomes equal to or longer than a reference, the driving control unit causes the vehicle to run in a predetermined form.

(2): In the aspect (1) described above, the predetermined form is a mode of repeatedly increasing and decreasing a distance between the vehicle and the traffic participant.

(3): In the aspect (2) described above, in a case in which it is not determined by the recognition unit that the traffic participant is aware of the presence of the vehicle even after elapse of a first predetermined time, the driving control unit shortens a period at which the distance between the vehicle and the traffic participant is increased and decreased.

(4): In the aspect (3) described above, the driving control unit increases a shortest distance between the vehicle and the traffic participant as the period at which the distance between the vehicle and the traffic participant is increased and decreased is further shortened.

(5): In the aspect (1) described above, the driving control unit causes the vehicle to run while avoiding contact with the traffic participant in a case in which a distance between the traffic participant and an end part of a road on a side opposite to the traffic participant in a width direction of the road with the vehicle interposed therebetween is equal to or longer than a first predetermined distance, causes the vehicle to run behind the traffic participant in a case in which the distance is shorter than the first predetermined distance and is equal to or longer than a second predetermined distance, and in a case in which a period of running behind the traffic participant becomes equal to or longer than a reference, causes the vehicle to run in a predetermined form.

(6): In the aspect (1) described above, in a case in which the vehicle is caused to run in the predetermined form, once it is determined by the recognition unit that the traffic participant is aware of the presence of the vehicle, the driving control unit causes the vehicle to end the running in the predetermined form.

(7): In the aspect (5) described above, the recognition unit also recognizes the distance while the vehicle is caused to run in the predetermined form by the driving control unit, and in a case in which the vehicle is caused to run in the predetermined form, once it is determined by the recognition unit that the distance is equal to or longer than the first predetermined distance, the driving control unit causes the vehicle to end the running in the predetermined form.

(8): In the aspect (1) described above, in a case in which a second predetermined time, which is longer than a first predetermined time, elapses after the vehicle is caused to start running in the predetermined form, the driving control unit causes the vehicle to end the running in the predetermined form.

(9): A vehicle control method according to one aspect of the present invention is a vehicle control method using a vehicle control device, the vehicle control method including: recognizing a peripheral situation of a vehicle; automatically controlling acceleration/deceleration and steering of the vehicle on the basis of the recognized peripheral situation; determining whether or not a traffic participant present in an advancement direction of the vehicle is aware of the presence of the vehicle; and automatically controlling steering of the vehicle such that the vehicle is caused to run behind the traffic participant in a case in which the traffic participant advancing in the same direction as that of the vehicle is recognized in the advancement direction of the vehicle and it is determined that the traffic participant is not aware of the presence of the vehicle, and the vehicle is caused to run in a predetermined form in a case in which a period of running behind the traffic participant becomes equal to or longer than a reference.

(10): A storage medium according to one aspect of the present invention is a (non-transitory computer-readable) storage medium having a program stored thereon, causing a vehicle control device to execute: recognizing a peripheral situation of a vehicle; automatically controlling acceleration/deceleration and steering of the vehicle on the basis of the recognized peripheral situation; determining whether or not a traffic participant present in an advancement direction of the vehicle is aware of the presence of the vehicle; and automatically controlling steering of the vehicle such that the vehicle is caused to run behind the traffic participant in a case in which the traffic participant advancing in the same direction as that of the vehicle is recognized in the advancement direction of the vehicle, and it is determined that the traffic participant is not aware of the presence of the vehicle, and the vehicle is caused to run in a predetermined form in a case in which a period of running behind the traffic participant becomes equal to or longer than a reference.

According to (1) to (10), driving control of a subject vehicle in the case of running behind or bypassing traffic participants can be performed more appropriately.

### BRIEF DESCRIPTION OF THE DRAWINGS

FIG. 1 is a configuration diagram of a vehicle system using a vehicle control device according to an embodiment;

FIG. 2 is a functional configuration diagram of a first control unit and a second control unit;

FIG. 3 is a diagram illustrating one example of processes performed by a traffic participant correspondence control unit in a case in which a pedestrian is present in an advancement direction of a subject vehicle;

FIG. 4 is a diagram illustrating one example of a relation between a subject vehicle and a pedestrian during run in a predetermined form;

FIG. 5 is a flowchart illustrating a part of the flow of a process of causing a subject vehicle to run in a predetermined form using an automated driving control device according to a first embodiment;

FIG. 6 is a diagram illustrating an example in which a relation between a subject vehicle and a pedestrian during run in a predetermined form according to a second embodiment transitions;

FIG. 7 is a flowchart illustrating a part of the flow of a process of causing a subject vehicle M to run in a predetermined form using an automated driving control device according to the second embodiment;

FIG. 8 is a flowchart illustrating a part of the flow of a process of causing a subject vehicle M to run in a predetermined form using an automated driving control device according to a third embodiment; and

FIG. 9 is a diagram showing one example of the hardware configuration of an automated driving control device according to an embodiment.

### DETAILED DESCRIPTION OF THE INVENTION

Hereinafter, a vehicle control device, a vehicle control method, and a program according to embodiments of the present invention will be described with reference to the drawings. Hereinafter, although a case in which a rule of left-side traffic is applied will be described, the left side and the right side may be interchanged in a case in which a rule of right-side traffic is applied.

### First Embodiment

### [Entire Configuration]

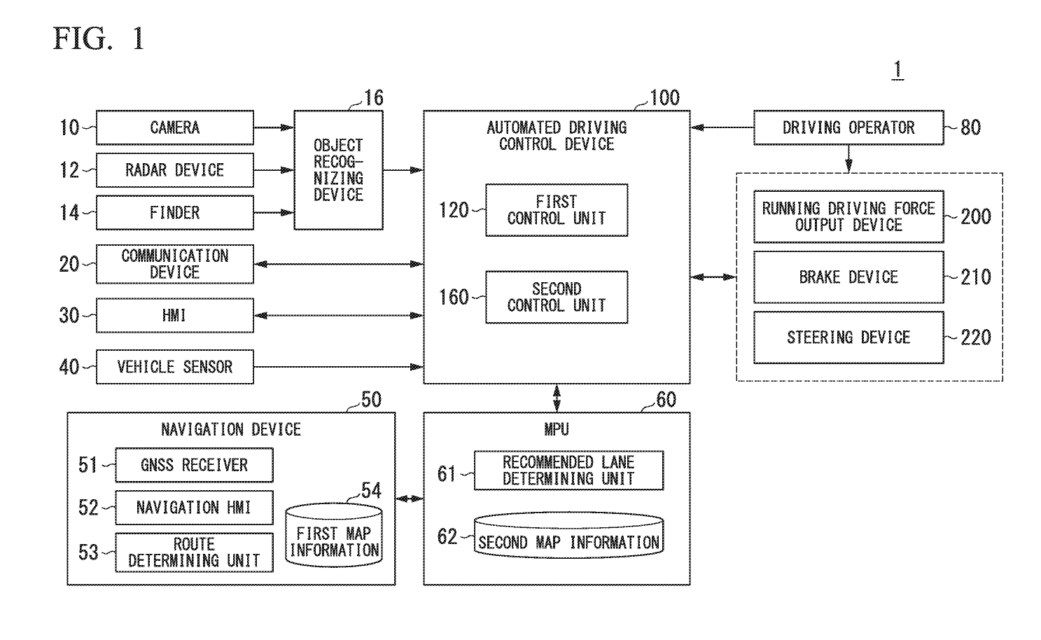

FIG. 1 is a configuration diagram of a vehicle system 1 using a vehicle control device according to an embodiment. A vehicle in which the vehicle system 1 is mounted is, for example, a vehicle having two wheels, three wheels, four wheels, or the like, and a driving source thereof is an internal combustion engine such as a diesel engine or a gasoline engine, an electric motor, or a combination thereof. The electric motor operates using power generated using a power generator connected to an internal combustion engine or power discharged from a secondary cell or a fuel cell.

The vehicle system 1, for example, includes a camera 10, a radar device 12, a finder 14, an object recognizing device 16, a communication device 20, a human machine interface (HMI) 30, a vehicle sensor 40, a navigation device 50, a map positioning unit (MPU) 60, a driving operator 80, an automated driving control device 100, a running driving force output device 200, a brake device 210, and a steering device 220. Such devices and units are interconnected using a multiplex communication line such as a controller area network (CAN) communication line, a serial communication line, a radio communication network, or the like. The configuration illustrated in FIG. 1 is merely one example, and thus parts of the configuration may be omitted or other additional components may be added. The automated driving control device 100 is one example of a “vehicle control device.”

The camera 10, for example, is a digital camera using a solid-state imaging device such as a charge coupled device (CCD) or a complementary metal oxide semiconductor (CMOS). The camera 10 is installed at an arbitrary place on a vehicle in which the vehicle system 1 is mounted (hereinafter, referred to as a subject vehicle M).

In a case of forward imaging, the camera 10 is installed at an upper part of a front windshield, a rear face of a rear-view mirror, or the like. The camera 10, for example, repeatedly images the vicinity of the subject vehicle M periodically. The camera 10 may be a stereo camera.

The radar device 12 emits radio waves such as millimeter waves to the vicinity of the subject vehicle M and detects at least a position of (a distance and an azimuth to) an object by detecting radio waves (reflected waves) reflected by the object. The radar device 12 is installed at an arbitrary place on the subject vehicle M. The radar device 12 may detect a position and a speed of an object using a frequency modulated continuous wave (FM-CW) system.

The finder 14 is a light detection and ranging (LIDAR) device. The finder 14 emits light to the vicinity of the subject vehicle M and measures scattering light. The finder 14 detects a distance to a target on the basis of a time from light emission to light reception. The emitted light, for example, is a pulse-form laser light. The finder 14 is mounted at an arbitrary position on the subject vehicle M.

The object recognizing device 16 may perform a sensor fusion process on results of detection using some or all of the camera 10, the radar device 12, and the finder 14, thereby allowing recognition of a position, a type, a speed, and the like of an object. The object recognizing device 16 outputs a result of recognition to the automated driving control device 100. The object recognizing device 16 may output results of detection using the camera 10, the radar device 12, and the finder 14 to the automated driving control device 100 as they are. The object recognizing device 16 may be omitted from the vehicle system 1.

The communication device 20, for example, communicates with other vehicles present in the vicinity of the subject vehicle M using a cellular network, a Wi-Fi network, Bluetooth (registered trademark), dedicated short range communication (DSRC), or the like or communicates with various server apparatuses through a radio base station.

The HMI 30 presents various types of information to an occupant of the subject vehicle M and receives an input operation performed by a vehicle occupant. The HMI 30 may include various display devices, a speaker, a buzzer, a touch panel, switches, keys, and the like.

The vehicle sensor 40 includes a vehicle speed sensor that detects a speed of the subject vehicle M, an acceleration sensor that detects an acceleration, a yaw rate sensor that detects an angular velocity around a vertical axis, an azimuth sensor that detects the azimuth of the subject vehicle M, and the like.

The navigation device 50, for example, includes a global navigation satellite system (GNSS) receiver 51, a navigation HMI 52, and a route determining unit 53. The navigation device 50 stores first map information 54 in a storage device such as a hard disk drive (HDD) or a flash memory. The GNSS receiver 51 identifies a position of a subject vehicle M on the basis of signals received from GNSS satellites. The position of the subject vehicle M may be identified or complemented by an inertial navigation system (INS) using an output of the vehicle sensor 40. The navigation HMI 52 includes a display device, a speaker, a touch panel, a key, and the like. A part or the whole of the navigation HMI 52 and the HMI 30 described above may be configured to be shared. The route determining unit 53, for example, determines a route to a destination input by a vehicle occupant using the navigation HMI 52 (hereinafter referred to as a route on a map) from a position of the subject vehicle M identified by the GNSS receiver 51 (or an input arbitrary position) by referring to the first map information 54. The first map information 54, for example, is information in which a road form is represented by respective links representing a road and respective nodes connected using the links. The first map information 54 may include a curvature of each road, point of interest (POI) information, and the like. The route on the map is output to the MPU 60. In addition, the navigation device 50 may perform route guidance using the navigation HMI 52 on the basis of the route on the map. The navigation device 50, for example, may be realized by a function of a terminal device such as a smartphone or a tablet terminal held by a vehicle occupant. In addition, the navigation device 50 may transmit a current location and a destination to a navigation server through the communication device 20 and acquire a route equivalent to the route on the map received from the navigation server.

The MPU 60, for example, includes a recommended lane determining unit 61 and stores second map information 62 in a storage device such as an HDD or a flash memory. The recommended lane determining unit 61 divides a route on the map provided from the navigation device 50 into a plurality of blocks (for example, divides the route into blocks of 100 [m] in the advancement direction of the vehicle) and determines a recommended lane for each block by referring to the second map information 62. The recommended lane determining unit 61 determines on which of lanes numbered from the left side to run. In a case in which there is a branching place in the route on the map, the recommended lane determining unit 61 determines a recommended lane such that the subject vehicle M can run along a reasonable route for advancement to a branching destination.

The second map information 62 is map information having higher accuracy than the first map information 54. The second map information 62, for example, includes information of the center of respective lanes, information on boundaries between lanes, or the like. In addition, in the second map information 62, road information, traffic regulation information, address information (address and postal code), facility information, telephone number information, and the like may be included. The second map information 62 may be updated as needed by the communication device 20 communicating with another device.

The driving operator 80, for example, includes an acceleration pedal, a brake pedal, a shift lever, a steering wheel, a steering wheel variant, a joystick, and other operators. A sensor detecting the amount of an operation or the presence/absence of an operation is installed in the driving operator 80, and a result of the detection is output to the automated driving control device 100 or some or all of the running driving force output device 200, the brake device 210, and the steering device 220.

The automated driving control device 100, for example, includes a first control unit 120 and a second control unit 160. Each of these constituent elements, for example, is realized by a hardware processor such as a central processing unit (CPU) executing a program (software). In addition, some or all of these constituent elements may be realized by hardware (a circuit unit; including circuitry) such as a large scale integration (LSI), an application specific integrated circuit (ASIC), a field-programmable gate array (FPGA), or a graphics processing unit (GPU) or may be realized by software and hardware in cooperation. The program may be stored in a storage device such as a hard disk drive (HDD) or a flash memory of the automated driving control device 100 in advance or may be stored in a storage medium such as a DVD or a CD-ROM that can be loaded or unloaded and installed in an HDD or a flash memory of the automated driving control device 100 by loading the storage medium into a drive device. A combination of the action plan generating unit 140 and the second control unit 160 is one example of a “driving control unit.” The driving control unit, for example, automatically controls acceleration/deceleration and steering in the speed or steering of the subject vehicle M on the basis of a peripheral situation recognized by the recognition unit 130.

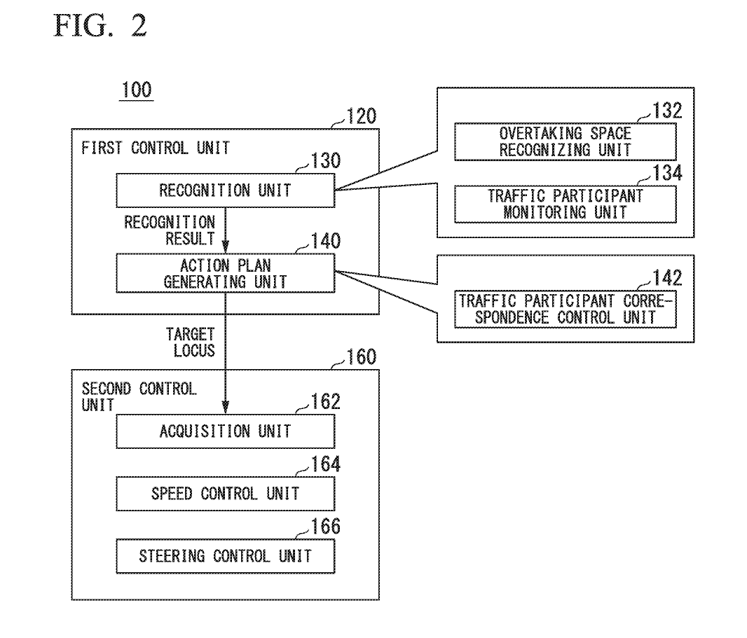

FIG. 2 is a functional configuration diagram of the first control unit 120 and the second control unit 160. The first control unit 120, for example, includes a recognition unit 130 and an action plan generating unit 140. The first control unit 120, for example, simultaneously realizes functions using artificial intelligence (AI) and functions using a model provided in advance. For example, a function of “recognizing an intersection” may be realized by executing recognition of an intersection using deep learning or the like and recognition based on conditions given in advance (a traffic light, road markings, and the like that can be used for pattern matching are present) at the same time and comprehensively evaluating both the recognitions by assigning scores to them. Accordingly, the reliability of automated driving is secured.

The recognition unit 130 recognizes states such as a position, a speed, an acceleration, and the like of each object present in the vicinity of the subject vehicle M on the basis of information input from the camera 10, the radar device 12, and the finder 14 through the object recognizing device 16. In objects, for example, moving bodies such as a pedestrian, a bicycle, other vehicles and obstacles such as construction sites are included. The position of an object, for example, is recognized as a position on an absolute coordinate system having a representative point (the center of gravity, the center of a driving shaft, or the like) of the subject vehicle M as its origin and is used for control. The position of an object may be represented as a representative point such as the center of gravity or a corner of an object or may be represented in a represented area. In a case in which an object is another vehicle, a “state” of the object may include an acceleration, a jerk, or an “action state” (for example, whether or not the object is changing lanes or is to change lanes) of an object. In a case in which an object is a pedestrian, a “state” of an object may include a direction in which the object moves or an “action state” (for example, whether or not it is crossing a road or it will cross a road). The recognition unit 130 may recognize the amount of movement of an object in a sampling period.

The recognition unit 130, for example, recognizes a lane (road) in which the subject vehicle M is running For example, the recognition unit 130 may recognize a running lane by comparing a pattern of road partition lines acquired from the second map information 62 (for example, an array of solid lines and broken lines) with a pattern of road partition lines in the vicinity of the subject vehicle M that has been recognized from an image captured by the camera 10. The recognition unit 130 is not limited to recognizing road partition lines and may recognize a running lane by recognizing running road boundaries (road boundaries) including a road partition line, a road shoulder, curbstones, a median strip, a guardrail, a concrete block wall, a side ditch, a fence, and the like. In the recognition, the position of the subject vehicle M acquired from the navigation device 50 or a result of the process executed by an INS may be additionally taken into account. The recognition unit 130 recognizes a width of a road on which the subject vehicle M runs. In this case, the recognition unit 130 may recognize a road width from an image captured by the camera 10 or may recognize a road width from a road partition line acquired from the second map information 62. The recognition unit 130 may recognize a width (for example, a vehicle width of another vehicle), a height, a shape, and the like of an obstacle on the basis of an image captured by the camera 10. The recognition unit 130 recognizes a temporary stop line, red light, a toll gate, and other road events.

When a running lane is recognized, the recognition unit 130 recognizes a position and a posture of the subject vehicle M with respect to the running lane. The recognition unit 130, for example, may recognize a deviation of a representative point on the subject vehicle M from the center of the lane and an angle of the advancement direction of the subject vehicle M formed with respect to a line along the center of the lane as a relative position and a posture of the subject vehicle M with respect to the running lane. Instead of this, the recognition unit 130 may recognize a position of a representative point on the subject vehicle M with respect to a one side end part (a road partition line or a road boundary) of the running lane or the like as a relative position of the subject vehicle M with respect to the running lane. The recognition unit 130 may recognize structures (for example, a telephone pole, a median strip, and the like) on a road on the basis of the first map information 54 or the second map information 62. The functions of an overtaking space recognizing unit 132 and a traffic participant monitoring unit 134 of the recognition unit 130 will be described later.

The action plan generating unit 140 automatically (without depending on a driver's operation) generates a target locus along which the subject vehicle M will run in the future such that the subject vehicle basically runs on a recommended lane determined by the recommended lane determining unit 61 and can respond to a peripheral situation of the subject vehicle M. The target locus is a locus that is a target along which the representative point of the subject vehicle M passes. The target locus, for example, includes a speed element. For example, the target locus is represented as a sequence of places (locus points) at which the subject vehicle M will arrive. A locus point is a place at which the subject vehicle M will arrive at respective predetermined running distances (for example, about every several [m]) as distances along the road, and separately from that, a target speed and a target acceleration for each of predetermined sampling times (for example, a fraction of a [sec]) are generated as a part of the target locus. A locus point may be a position at which the subject vehicle M will arrive at a predetermined sampling time for each of the sampling time. In such a case, information of a target speed or a target acceleration is represented using intervals between the locus points.

When a target locus is generated, the action plan generating unit 140 may set an event of automated driving. As events of automated driving, there are a constant-speed running event, a low-speed running-behind event, a lane change event, a branching event, a merge event, an overtaking event, and the like. The action plan generating unit 140 generates a target locus according to operated events. The function of a traffic participant correspondence control unit 142 of the action plan generating unit 140 will be described later.

The second control unit 160 performs control of the running driving force output device 200, the brake device 210, and the steering device 220 such that the subject vehicle M passes along a target locus generated by the action plan generating unit 140 at a scheduled time.

The second control unit 160, for example, includes an acquisition unit 162, a speed control unit 164, and a steering control unit 166. The acquisition unit 162 acquires information of a target locus (locus points) generated by the action plan generating unit 140 and stores the target locus information in a memory (not illustrated). The speed control unit 164 controls the running driving force output device 200 or the brake device 210 on the basis of a speed element accompanying the target locus stored in the memory. The steering control unit 166 controls the steering device 220 in accordance with a degree of curvature of the target locus stored in the memory. The processes of the speed control unit 164 and the steering control unit 166, for example, are realized by a combination of feed forward control and feedback control. For example, the steering control unit 166 may execute feed forward control according to the curvature of a road in front of the subject vehicle M and feedback control based on a deviation from the target locus in combination.

The running driving force output device 200 outputs a running driving force (torque) used for a vehicle to run to driving wheels. The running driving force output device 200, for example, includes a combination of an internal combustion engine, an electric motor, a transmission, and the like and an ECU controlling these components. The ECU controls the components described above in accordance with information input from the second control unit 160 or information input from the driving operator 80.

The brake device 210, for example, includes a brake caliper, a cylinder that delivers hydraulic pressure to the brake caliper, an electric motor that generates hydraulic pressure in the cylinder, and a brake ECU. The brake ECU performs control of the electric motor in accordance with information input from the second control unit 160 or information input from the driving operator 80 such that a brake torque according to a brake operation is output to each vehicle wheel. The brake device 210 may include a mechanism delivering hydraulic pressure generated in accordance with an operation on the brake pedal included in the driving operators 80 to the cylinder through a master cylinder as a backup. The brake device 210 is not limited to the configuration described above and may be an electronically-controlled hydraulic brake device that delivers hydraulic pressure in the master cylinder to a cylinder by controlling an actuator in accordance with information input from the second control unit 160.

The steering device 220, for example, includes a steering ECU and an electric motor. The electric motor, for example, changes the direction of the steering wheel by applying a force to a rack and pinion mechanism. The steering ECU changes the direction of the steering wheel by driving an electric motor in accordance with information input from the second control unit 160 or information input from the driving operator 80.

### [Control at Time of Bypassing Traffic Participant]

Hereinafter, a series of processes performed by the automated driving control device 100 at the time of bypassing a traffic participant will be described. In the following example, particularly, a view in which a notification form using an output device having a high volume such as a horn is preferably avoided is assumed. The assumed view, for example, is a view in which the subject vehicle is running on a narrow road at midnight or early morning or in a quiet residential area. Here, a narrow road, for example, is a road having a road width for which it is difficult for the subject vehicle M to bypass a traffic participant with a gap, for which there is a sufficiently low possibility of coming into contact with each other in a state in which the traffic participant is not aware of the subject vehicle M, being maintained. A case in which a traffic participant advancing on a narrow road is a child or an old person even if it is not midnight or early morning may be included in the assumed view. The automated driving control device 100 determines whether or not a view is the assumed view as described above and may perform control described below in a case in which the assumed view is determined.

### (Function of Overtaking Space Recognizing Unit)

For example, in a case in which the recognition unit 130 recognizes that a traffic participant other than the subject vehicle M advancing in the same direction is present in an advancement direction of a road on which the subject vehicle M runs, the overtaking space recognizing unit 132 recognizes a space for the subject vehicle M to run by bypassing the traffic participant. Here, traffic participants, for example, are moving bodies such as a single or a plurality of pedestrians, bicycles, and the like among objects recognized by the recognition unit 130 and are present on a road on which the subject vehicle M runs. In the following description, representatively, a traffic participant is assumed as a single pedestrian (hereinafter, a pedestrian P1). Hereinafter, while only a case in which the subject vehicle M bypasses the pedestrian P1 moving in the same direction as the advancement direction of the subject vehicle M will be illustrated and described, the embodiment is not limited thereto and, for example, thus may be applied also to a case in which the subject vehicle M bypasses a traffic participant moving in a direction opposite to the advancement direction of the subject vehicle M.

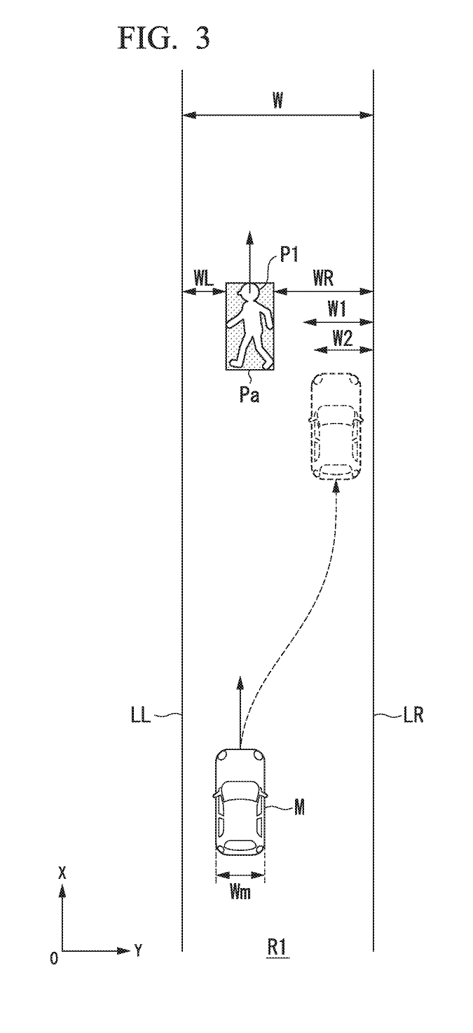

FIG. 3 is a diagram illustrating processes performed by the first control unit 120 and the second control unit 160 in a case in which a pedestrian is present in an advancement direction of the subject vehicle M. In the example illustrated in FIG. 3, there is a pedestrian P1 in the advancement direction (an X-axis direction in FIG. 3) of the subject vehicle M, which has a vehicle width Wm, running on a road R1 partitioned by left and right road partition lines LL and LR. In this case, the subject vehicle M tries to perform detour driving by passing the right side of the pedestrian P1.

For example, in a case in which a pedestrian P1 present in the advancement direction of the subject vehicle M is recognized by the recognition unit 130, the overtaking space recognizing unit 132 sets a contact estimation area Pa in which there is a possibility of coming into contact with the pedestrian P1 on the basis of contour information of the pedestrian P1. The overtaking space recognizing unit 132 derives a gap (road width) W between the road partition lines LL and LR. In addition, the overtaking space recognizing unit 132 derives both a gap WL between a left end of the contact estimation area Pa and the road partition line LL and a gap WR between a right end of the contact estimation area Pa and the road partition line LR and selects a larger one thereof as a space for detour running In the example illustrated in FIG. 3, the gap WR is larger than the gap WL. Accordingly, the overtaking space recognizing unit 132 outputs the gap W, the gap WR, and the contact estimation area Pa to the action plan generating unit 140.

In a case in which there is a running road boundary (for example, a guard rail, a protection fence partitioning a walking road and a vehicle road, or a bumping post) other than the road partition lines LL and LR between the pedestrian P1 and a road along which a target locus of the subject vehicle M is generated, the overtaking space recognizing unit 132 derives respective gaps on the basis of not the pedestrian P1 but the recognized running road boundary.

### (Function of Traffic Participant Monitoring Unit)

The traffic participant monitoring unit 134, for example, analyzes a behavior of the pedestrian P1, which has been recognized by the recognition unit 130, within a predetermined time using a function according to AI of the first control unit 120 and determines whether or not the pedestrian P1 is aware of the presence of the subject vehicle M on the basis of a result of the analysis. For example, in a case in which a stop motion of the pedestrian P1 is recognized, the traffic participant monitoring unit 134 determines that the pedestrian P1 is aware of the presence of the subject vehicle M. The traffic participant monitoring unit 134 may determine that the pedestrian P1 is aware of the presence of the subject vehicle M by estimating a line of sight of the pedestrian P1 from the direction of a face of the pedestrian P1. For example, in a case in which at least a half or more of the face of the pedestrian P1 has been recognized for a predetermined time or more, the traffic participant monitoring unit 134 determines that there is a high possibility that the pedestrian P1 has visually checked the presence of the subject vehicle M and determines that the pedestrian P1 is aware of the presence of the subject vehicle M.

For example, in a case in which the presence of the pedestrian P1 is recognized in the advancement direction of the subject vehicle M by the recognition unit 130, the traffic participant monitoring unit 134 may estimate an amount of movement xp1 relating to a direction vertical to the advancement direction (hereinafter, referred to as a horizontal direction) in the amount of movement thereof and determine whether or not the pedestrian P1 is aware of the presence of the subject vehicle M. The amount of movement xp1, for example, is an amount of movement of the pedestrian P1 in the horizontal direction from the inner side of the road R1 (for example, the center of the road) to the outer side (for example, the road partition line LL). The amount of movement xp1 may be an amount of movement for moving in the horizontal direction such that the traffic participant is further away from the side bypassed by the subject vehicle M. In a case in which the amount of movement xp1 is equal to or larger than a predetermined amount, the traffic participant monitoring unit 134 determines that the pedestrian P1 is aware of the presence of the subject vehicle M.

For example, in a case in which at least a half or more of the face of the pedestrian P1 has been recognized only for a time that is shorter than a predetermined time or in a case in which the amount of change in the amount of movement xp1 of the pedestrian P1 is less than a predetermined amount, the traffic participant monitoring unit 134 determines that the pedestrian P1 is not aware of the presence of the subject vehicle M.

The traffic participant monitoring unit 134 repeatedly determines whether or not the traffic participant is aware of the presence of the subject vehicle M at constant intervals and outputs a result of the latest determination for each time to the action plan generating unit 140.

### (Function of Traffic Participant Correspondence Control Unit)

The traffic participant correspondence control unit 142 controls the subject vehicle M by selecting correspondence that is appropriate for the pedestrian P1 on the basis of various kinds of information input from the overtaking space recognizing unit 132.

The traffic participant correspondence control unit 142, for example, determines whether or not the gap WR is equal to or larger than a first predetermined distance W1. Here, the first predetermined distance W1, for example, is a road width for which there is a sufficiently low possibility of the pedestrian P1 and the subject vehicle M coming into contact with each other when the subject vehicle M overtakes the pedestrian P1 even in a case in which the pedestrian P1 is not aware of the subject vehicle M. The first predetermined distance W1, for example, is derived from a sum of the vehicle width Wm of the subject vehicle M and a distance α1. The distance α1 may be a fixed distance (for example, 70 [cm]) or may be derived on the basis of a walking stride of the pedestrian P1, an area of the contact estimation area Pa, and the like recognized by the recognition unit 130.

In a case in which it is determined the gap WR is equal to or larger than the first predetermined distance W1, the traffic participant correspondence control unit 142 determines that the subject vehicle M can bypass the pedestrian P1. On the other hand, in a case in which it is determined that the gap WR is not equal to or larger than the first predetermined distance W1, the traffic participant correspondence control unit 142 determines whether or not the gap WR is smaller than the first predetermined distance and is equal to or larger than a second predetermined distance W2. Here, the second predetermined distance W2, for example, is a road width for which there is a sufficiently low possibility of the pedestrian P1 and the subject vehicle M coming into contact with each other when the subject vehicle M bypasses the pedestrian P1 in a case in which the pedestrian P1 is aware of the subject vehicle M. The second predetermined distance W2, for example, similar to the first predetermined distance W1, is derived from a sum of the vehicle width Wm of the subject vehicle M and a distance α2. The distance α2, similar to the distance α1, may be a fixed distance (for example, 30 [cm]) or may be derived on the basis of a walking stride of the pedestrian P1, an area of the contact estimation area Pa, and the like recognized by the recognition unit 130.

In a case in which it is determined that the gap WR is smaller than the first predetermined distance W1 and is equal to or larger than the second predetermined distance W2, the traffic participant correspondence control unit 142 determines that the subject vehicle M can bypass the pedestrian P1 in a case in which the pedestrian P1 is aware of the presence of the subject vehicle M. On the other hand, in a case in which it is determined that the gap WR is smaller than the first predetermined distance W1 and is not equal to or larger than the second predetermined distance W2, the traffic participant correspondence control unit 142 determines that it is difficult for the subject vehicle M to bypass the pedestrian P1.

### (Process of Generating Target Locus Using Traffic Participant Correspondence Control Unit)

In a case in which it is determined that it is difficult for the subject vehicle M to bypass the pedestrian P1, the traffic participant correspondence control unit 142 controls the subject vehicle M such that it runs behind the pedestrian P1. On the other hand, in a case in which it is determined that the subject vehicle M can bypass the pedestrian P1, the traffic participant correspondence control unit 142 controls the subject vehicle M such that it runs by bypassing the pedestrian P1.

In a case in which the pedestrian P1 is aware of the presence of the subject vehicle M and it is determined that the subject vehicle M can bypass the pedestrian P1, the traffic participant correspondence control unit 142 causes the subject vehicle M to run behind the pedestrian P1 until a result of determination indicating that the pedestrian P1 is aware of the subject vehicle M is input. Thereafter, at a time point at which a result of determination indicating that the pedestrian P1 is aware of the subject vehicle M is input from the traffic participant monitoring unit 134, the traffic participant correspondence control unit 142 controls the subject vehicle M such that it runs by bypassing the pedestrian P1.

In a case in which it is determined that the subject vehicle M can run by bypassing the pedestrian P1 and in a case in which a result of determination indicating that the pedestrian P1 is aware of the subject vehicle M is not input from the traffic participant monitoring unit 134, the traffic participant correspondence control unit 142 causes the subject vehicle M to run behind the pedestrian P1 with a gap between the pedestrian P1 and the subject vehicle M maintained as being equal to or longer than a reference distance so as to notify the pedestrian P1 of the presence of the subject vehicle M for at least a predetermined unit. Here, the predetermined unit may be set as a distance (for example, about 5 [m]) or a time (for example, about 10 [seconds]). In other words, the traffic participant correspondence control unit 142 may cause the subject vehicle M to run in a predetermined form in a case in which the subject vehicle M runs behind the pedestrian P1 for 5 [m] or more or may cause the subject vehicle M to run in a predetermined form in a case in which the subject vehicle M runs behind the pedestrian P1 for 10 [seconds] or more. The reference distance may be a fixed distance or a distance that is variably set on the basis of the speed of the subject vehicle M. The reference distance, for example, may be adjusted on the basis of a projection area of the front face of the subject vehicle M or the vehicle width Wm and thus may be adjusted such that, in a case in which the projection area of the front face of the subject vehicle M or the vehicle width Wm is larger, the reference distance is increased in proportion thereto.

In a case in which a period in which the subject vehicle M runs behind the pedestrian P1 is equal to or longer than a predetermined unit, the traffic participant correspondence control unit 142 causes the subject vehicle M to run in a predetermined form. Here, causing the subject vehicle M to run in a predetermined form, for example, is subject vehicle M's repeatedly increasing or decreasing a gap between the pedestrian P1 and the subject vehicle M at a predetermined period.

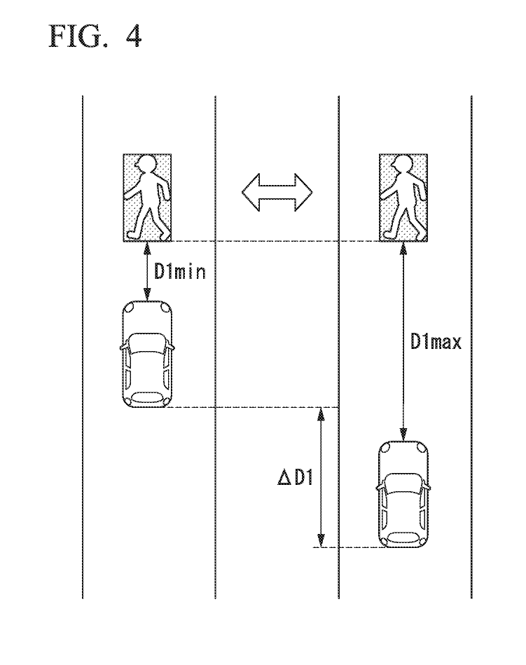

Hereinafter, one example of running in a predetermined form will be described with reference to FIG. 4. FIG. 4 is a diagram illustrating one example of a relation between a subject vehicle M during running in a predetermined form and a pedestrian P1.

On the left side of FIG. 4, a view in which a distance between the pedestrian P1 and the subject vehicle M is the shortest in running in the predetermined form is illustrated. On the right side of FIG. 4, a view in which the distance between the pedestrian P1 and the subject vehicle M is the longest in running in the predetermined form is illustrated.

The traffic participant correspondence control unit 142, for example, controls the speed of the subject vehicle M such that the distance between the pedestrian P1 and the subject vehicle M changes between a first shortest distance D1min and a first longest distance D1max at a predetermined period of about 10 to 15 [seconds]. A difference between the first shortest distance D1min and the first longest distance D1max is represented as a distance variation width ΔD1. The first shortest distance D1min, for example, is about 3 to 5 [m]. The first shortest distance D1min may be the same as the reference distance or different from the reference distance.

It is difficult for the pedestrian P1 to be aware of a sign of a following vehicle (for example, a road surface vibration or shaking of the air) moving at the same relative speed or with the same gap. For this reason, by changing the speed and the gap by causing the subject vehicle M to run in a predetermined form, the vehicle system 1 can increase the possibility that the pedestrian P1 is aware of the subject vehicle M.

In a case in which a result of determination indicating that the pedestrian P1 is aware of the subject vehicle M is input from the traffic participant monitoring unit 134 as a result of running in the predetermined form described above, the traffic participant correspondence control unit 142 ends the running in the predetermined form. As a result, the traffic participant correspondence control unit 142 causes the subject vehicle M to run by bypassing the right side of the pedestrian P1.

### [Process Flow]

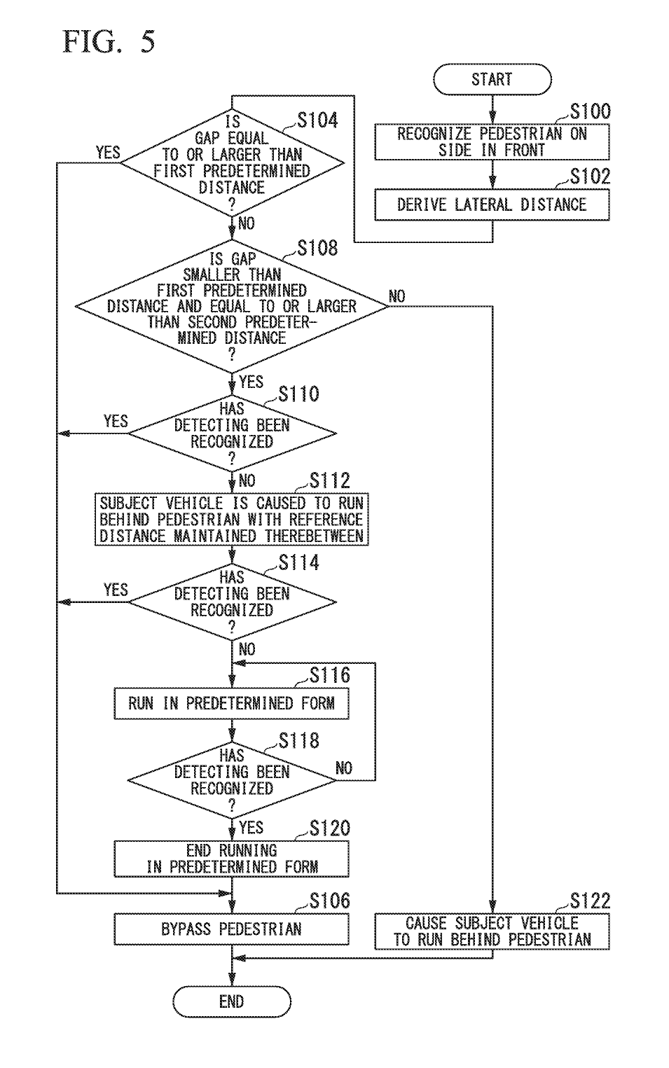

Hereinafter, one example of the flow of a process executed by the automated driving control device 100 in a case in which a pedestrian P1 is recognized by the recognition unit 130 will be described with reference to FIG. 5. FIG. 5 is a flowchart illustrating the flow of a process executed by the automated driving control device 100 according to the first embodiment. The process of this flowchart, for example, may be repeatedly executed at a predetermined period or at a predetermined timing.

First, the recognition unit 130 recognizes the pedestrian P1 in the advancement direction of the subject vehicle M (Step S100). Next, the overtaking space recognizing unit 132 derives a lateral distance (the gap WR and the like) of the pedestrian P1 recognized by the recognition unit 130 (Step S102) and outputs the derived lateral distance to the traffic participant correspondence control unit 142. Next, the traffic participant correspondence control unit 142 determines whether or not the gap WR is equal to or larger than the first predetermined distance W1 (Step S104). In a case in which it is determined that the gap WR is equal to or larger than the first predetermined distance W1, the traffic participant correspondence control unit 142 causes the subject vehicle M to run by bypassing the pedestrian P1 (Step S106). In a case in which it is determined that the gap WR is not equal to or larger than the first predetermined distance W1, the traffic participant correspondence control unit 142 determines whether or not the gap WR is smaller than the first predetermined distance and is equal to or larger than the second predetermined distance W2 (Step S108). In a case in which it is determined that the gap WR is smaller than the first predetermined distance and is equal to or larger than the second predetermined distance W2, the traffic participant correspondence control unit 142 determines whether or not it is recognized that the pedestrian P1 is aware of the subject vehicle M by the traffic participant monitoring unit 134 (Step S110).

In the process of Step S110, in a case in which it is not recognized that the pedestrian P1 is aware of the subject vehicle M by the traffic participant monitoring unit 134, the traffic participant correspondence control unit 142 causes the subject vehicle to run behind the pedestrian P1 with a gap between the pedestrian P1 and the subject vehicle M maintained to a reference distance (Step S112). Next, the traffic participant monitoring unit 134 determines again whether or not it is recognized by the traffic participant monitoring unit 134 that the pedestrian P1 is aware of the subject vehicle M (Step S114). In a case in which it is recognized by the traffic participant monitoring unit 134 that the pedestrian P1 is aware of the subject vehicle M, the traffic participant correspondence control unit 142 causes the process to proceed to Step S106. On the other hand, in a case in which it is not recognized by the traffic participant monitoring unit 134 that the pedestrian P1 is aware of the subject vehicle M, the traffic participant correspondence control unit 142 starts running in a predetermined form (Step S116).

The traffic participant monitoring unit 134 determines again whether or not it is recognized that the pedestrian P1 is aware of the subject vehicle M (Step S118). In a case in which it is recognized by the traffic participant monitoring unit 134 that the pedestrian P1 is aware of the subject vehicle M, the traffic participant correspondence control unit 142 ends the running in the predetermined form (Step S120) and causes the process to proceed to Step S106. On the other hand, in a case in which it is not recognized by the traffic participant monitoring unit 134 that the pedestrian P1 is aware of the subject vehicle M, the traffic participant correspondence control unit 142 returns the process to Step S116 again after a predetermined time elapses.

In a case in which it is not determined that the gap W is smaller than the first predetermined distance and is equal to or larger than the second predetermined distance W2 in the process of Step S108, the traffic participant correspondence control unit 142 causes the subject vehicle to run behind the pedestrian P1 while keeping a reference distance (Step S122). In this way, the process of this flowchart ends. In the process of

Step S118, in a case in which it is not recognized that the pedestrian P1 is aware of the subject vehicle M even after a predetermined time elapses, control of causing the subject vehicle to run behind the pedestrian P1 with a reference distance kept or stopping the subject vehicle M may be performed.

In a case in which a result of determination indicating that the road width W of the road R is equal to or larger than the first predetermined distance W1 is input by the traffic participant correspondence control unit 142 in the middle of running in the predetermined form, even when it is not recognized by the traffic participant monitoring unit 134 that the pedestrian P1 is aware of the subject vehicle M, the traffic participant monitoring unit 134 may cause the subject vehicle M to end the running in the predetermined form and causes the subject vehicle to run by bypassing the right side of the pedestrian P1.

According to the vehicle system 1 of the first embodiment described above, in a case in which a pedestrian P1 advancing in the same direction as that of the subject vehicle M is recognized in the advancement direction of the subject vehicle M by the traffic participant monitoring unit 134, and it is determined by the traffic participant monitoring unit 134 that the pedestrian P1 is not aware of the presence of the subject vehicle M, the traffic participant correspondence control unit 142 causes the subject vehicle M to run behind the pedestrian P1 and, in a case in which a period of the running behind the pedestrian P1 becomes equal to or longer than a reference, causes the subject vehicle M to run in the predetermined form of repeating increasing and decreasing of the distance between the subject vehicle M and the pedestrian P1, and accordingly, it becomes easier for the subject vehicle to enter the viewing field of the pedestrian P1 than that in a motion having a small change such as common running-behind, and driving control for causing the pedestrian P1 to be aware of the presence of the subject vehicle M can be performed. According to the vehicle system 1 of the first embodiment, the pedestrian P1 can be aware of a sign of the subject vehicle M more easily than in common running-behind, and driving control for causing the pedestrian P1 to be aware of the presence of the subject vehicle M can be performed without performing a notification using an output device having a high volume such as a horn.

### Second Embodiment

Next, a vehicle system 1 according to a second embodiment will be described. In the following description, the same name and the same reference sign will be assigned to parts having the same function as that described in the first embodiment, and detailed description of the function will not be presented. This similarly applies also to the other embodiments.

In the second embodiment, a running pattern in a predetermined form is changed by a traffic participant correspondence control unit 142, which is different from the first embodiment. Thus, hereinafter, the function of the traffic participant correspondence control unit 142 will be focused in description.

In order not to cause a road surface vibration or shaking of the air to be monotonous in accordance with running of the subject vehicle M in a predetermined form, for example, after a first predetermined time elapses after start of running in the predetermined form, the traffic participant correspondence control unit 142 changes the running pattern of the predetermined form. For example, in a case in which running in a predetermined form that is currently performed is running in which increasing or decreasing of the gap between the pedestrian P1 and the subject vehicle M illustrated in FIG. 4 is repeatedly performed at a predetermined period, the changing of a running pattern represents shortening the period by about 3 to 5 [seconds].

In a case in which the subject vehicle M performs changing of shortening the period, acceleration/deceleration of the subject vehicle M becomes higher than that of the running pattern before change, and accordingly, a road surface vibration and shaking of the air according to the subject vehicle M increase. Therefore, according to the vehicle system 1 of this embodiment, the possibility of the pedestrian P1 being aware of the presence of the subject vehicle M can be further increased without employing a notification form using an output device having a high volume.

In the second embodiment, in a case in which the changing of a running pattern described above is performed, in order to avoid a contact with the pedestrian P1 according to an increase in the acceleration/deceleration of the subject vehicle M, the traffic participant correspondence control unit 142 performs adjustment of configuring a shortest distance between the subject vehicle M and the pedestrian P1 to be larger than the first shortest distance D1min.

In a case in which a result of determination indicating that the pedestrian P1 is aware of the subject vehicle M is not input by the traffic participant monitoring unit 134 even after the first predetermined time elapses after start of running in the predetermined form of the running pattern after change, the traffic participant correspondence control unit 142 may change the running pattern for further shortening the period.

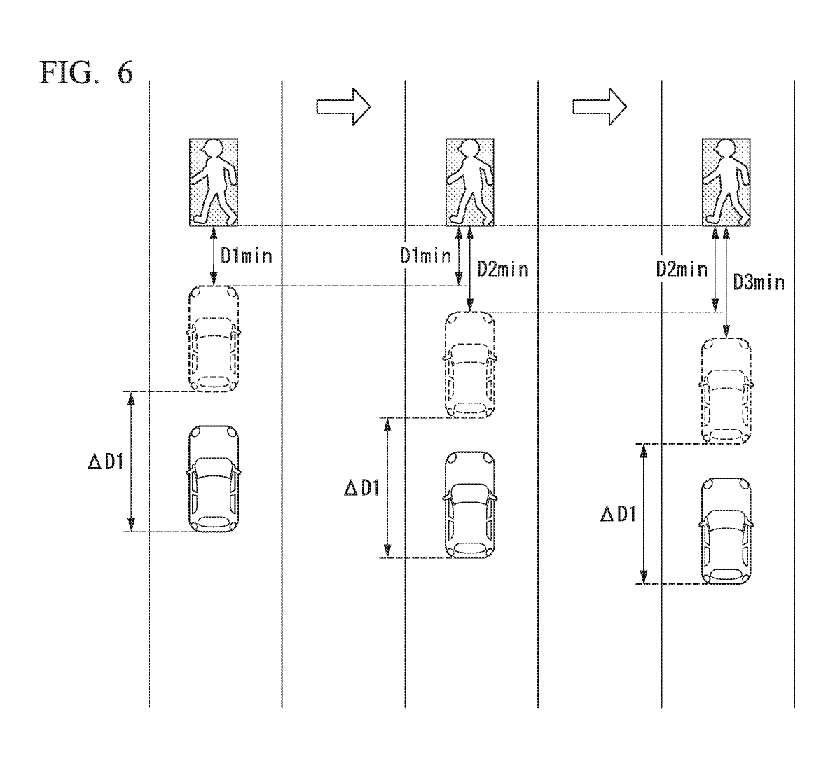

FIG. 6 is a diagram illustrating a view in which changing of a running pattern for further increasing a shortest distance between the subject vehicle M and the pedestrian P1 is perform in two stages. A left part in FIG. 6 is a diagram, similar to FIG. 4, illustrating a relation in which a distance between the pedestrian P and the subject vehicle M changes between a first shortest distance D1min and a first longest distance D1max. In a left part in FIG. 6, a position of the body of the subject vehicle M at which the position of the vehicle becomes a first longest distance D1max is denoted using a straight line, and a position of the body of the subject vehicle M at which the position of the body of the subject vehicle M becomes a first shortest distance D1min Similar to FIG. 4, a difference between the first shortest distance D1min and the first longest distance D1max is a distance variation width ΔD1.

A center part in FIG. 6 is a diagram illustrating a relation between the pedestrian P and the subject vehicle M when a period in which running in a predetermined form is shortened in a case in which a result of determination indicating that the pedestrian P1 is aware of the subject vehicle M is not input by the traffic participant monitoring unit 134 even when the first predetermined time elapses from the start of the running in the predetermined form represented in the left part in FIG. 6. In the center part in FIG. 6, a position of the body of the subject vehicle M at which the position of the vehicle becomes a second longest distance D2max is denoted by a solid line, and a position of the body of the subject vehicle M at which the position of the vehicle becomes a second shortest distance D2min is denoted by a dotted line.

In this case, the traffic participant correspondence control unit 142 keeps the distance variation width ΔD1 constant and further increases acceleration/deceleration when the subject vehicle M is caused to run in the predetermined form. Here, further increasing of acceleration/deceleration, for example, is increasing of a maximum acceleration/deceleration or configuring a rise of the acceleration/deceleration to be steeper. As the acceleration/deceleration increases, the traffic participant correspondence control unit 142 changes the shortest distance between the subject vehicle M and the pedestrian P1 to the second shortest distance D2min that is longer than the first shortest distance D1min.

A right part in FIG. 6 is a diagram illustrating a view in which a period at which the running is performed in the predetermined form is further shortened in a case in which a result of determination indicating that the pedestrian P1 is aware of the subject vehicle M is not input by the traffic participant monitoring unit 134 even when the first predetermined time elapses from start of the running in the predetermined form taking the second shortest distance D2min represented in the center part in FIG. 6. In the center part in FIG. 6, a position of the body of the subject vehicle M at which the position of the vehicle becomes a third longest distance D3max is denoted by a solid line, and a position of the body of the subject vehicle M at which the position of the vehicle becomes a third shortest distance D3min is denoted by a dotted line.

The traffic participant correspondence control unit 142 maintains the distance variation width ΔD1 constant and further increases acceleration/deceleration when the subject vehicle M is caused to run in the predetermined form. As the acceleration/deceleration increases, the traffic participant correspondence control unit 142 changes the shortest distance between the subject vehicle M and the pedestrian P1 to the third shortest distance D3min that is further longer than the second shortest distance D2min.

As illustrated in FIG. 6, after performing control such that the shortest distance is taken as a margin as the period is shortened, the traffic participant correspondence control unit 142 causes the subject vehicle M to run in the predetermined form. In this case, the change ratio of the road surface vibration or shaking of the air according to the subject vehicle M is expected to be higher than that before change. Accordingly, the vehicle system 1 according to this embodiment can further increase the possibility of causing the pedestrian P1 to be aware of the presence of the subject vehicle M.

Instead of details of the changing of the running pattern described above, the traffic participant correspondence control unit 142, for example, may perform a change of increasing the period or may change the value of the shortest distance (the first shortest distance D1max or the like) between the subject vehicle M and the pedestrian P1 or the distance variation width ΔD1. As replacement of changing of the running pattern in which the period is consecutively shortened as illustrated in FIG. 6, control of the subject vehicle M may be performed such that, after a first predetermined time elapses from running in the predetermined form, it is returned to running-behind at a reference distance, and, after the first predetermined time further elapses, running in the predetermined form is performed again.

### [Process Flow]

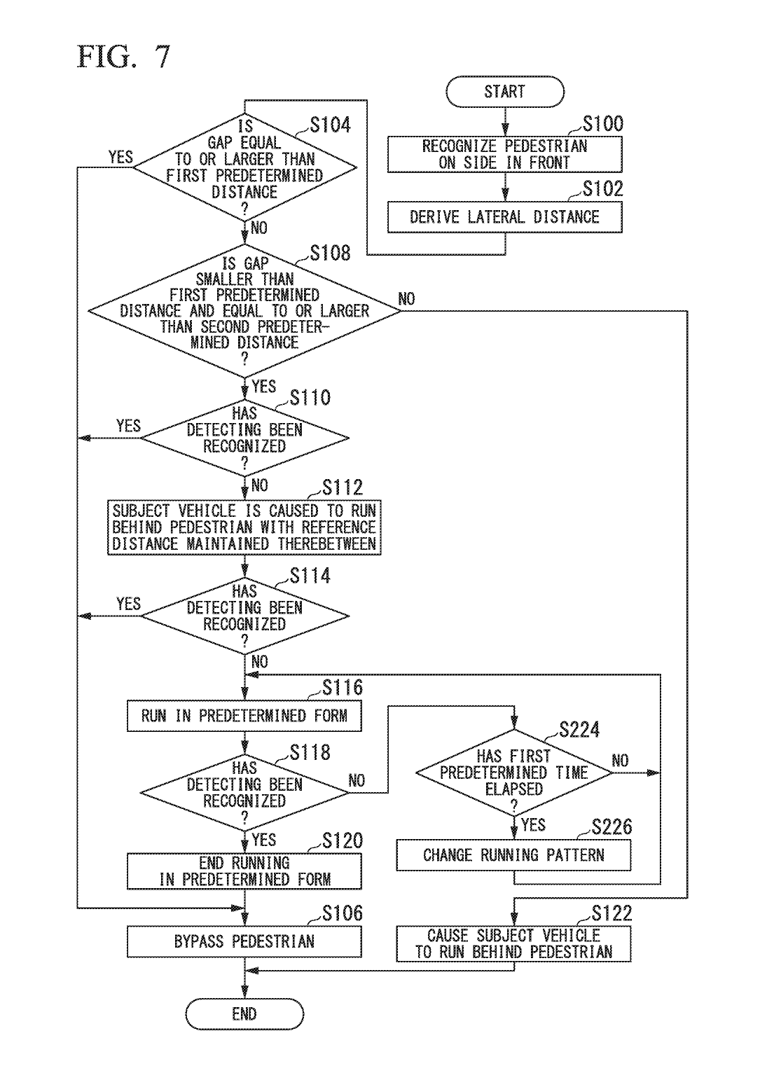

Hereinafter, one example of the flow of a process when the running pattern in a predetermined form is changed will be described with reference to FIG. 7. FIG. 7 is a flowchart illustrating the flow of a process executed by the automated driving control device 100 according to the second embodiment. In the flowchart illustrated in FIG. 7, compared to the flowchart illustrated in FIG. 5, processes of Steps S224 and S226 are added. Thus, hereinafter, the processes relating to Steps S224 and S226 will be mainly focused in description.

In the process of Step S118, in a case in which it is not determined by the traffic participant monitoring unit 134 that the pedestrian P1 is aware of the subject vehicle M, the traffic participant correspondence control unit 142 determines whether or not the first predetermined time has elapsed after start of running in the predetermined form (Step S224). In a case in which it is determined that the first predetermined time has elapsed after start of the running in the predetermined form, the traffic participant correspondence control unit 142 changes the running pattern (Step S226).

In the process of Step S224, in a case in which it is not determined that the first predetermined time has elapsed after start of running in the predetermined time, the process is returned to Step S116 again after a predetermined time elapses. In this way, the description of this flowchart ends. In the processes of Steps S116 to S226, in a case in which it is not recognized that the pedestrian P1 is aware of the subject vehicle M even in a case in which changing of the running pattern has been performed a predetermined number of times, control may be performed such that the subject vehicle M runs behind the pedestrian P1 with a reference distance maintained therebetween, or the subject vehicle M is stopped.

As described above, according to the vehicle system 1 of the second embodiment, in addition to acquisition of the effects similar to those of the first embodiment, in a case it is not determined by the traffic participant monitoring unit 134 that the pedestrian P1 is aware of the presence of the subject vehicle M even after the first predetermined time elapses after the running in the predetermined form is started, the traffic participant correspondence control unit 142 shortens the period of the running in the predetermined form in which the distance between the subject vehicle M and the pedestrian P1 is increased and decreased, whereby the possibility of the pedestrian P1 being aware of the presence of the subject vehicle M can be further increased. By increasing the shortest distance between the subject vehicle M and the pedestrian P1 as the period of the running in the predetermined form is further shortened, the traffic participant correspondence control unit 142 can increase the possibility of the pedestrian P1 being aware of the presence of the subject vehicle M with a state, in which there is a sufficiently low possibility of coming into contact between the subject vehicle M and the pedestrian P1, maintained.

### Third Embodiment

Next, a vehicle system 1 according to a third embodiment will be described. The third embodiment is different from the second embodiment in that a second predetermined time that is an upper limit time of running in a predetermined form is set by a traffic participant correspondence control unit 142. Thus, hereinafter, mainly, the function of the traffic participant correspondence control unit 142 will be focused in description.

According to the control of running in the predetermined form of the first embodiment and the second embodiment described above, there is a possibility of running excessively using the energy of a driving source in the subject vehicle M. For this reason, it is preferable that a time during which the subject vehicle M is caused to run in the predetermined form is extremely short. In a case in which it is determined by the traffic participant monitoring unit 134 that a pedestrian P1 is not aware of the presence of the subject vehicle M even when a second predetermined time (for example, about 1 to 2 (minutes)) longer than a first predetermined time has elapsed after start of running in the predetermined form, it is assumed that the possibility of the pedestrian P1 being aware of the subject vehicle M is low even if the subject vehicle M is caused to further continue to run in the predetermined form.

Thus, in the third embodiment, in a case it is determined by the traffic participant monitoring unit 134 that the pedestrian P1 is not aware of the presence of the subject vehicle M even when a second predetermined time that is an upper limit time elapses after start of running in the predetermined form, the running in the predetermined form for the pedestrian P1 ends, and running-behind in which the subject vehicle runs with a gap between the pedestrian P1 and the subject vehicle M maintained as an arbitrary reference distance is performed. In the third embodiment, the subject vehicle M allows a vehicle occupant of the subject vehicle M to determine whether or not a notification form using a horn or the like is selected, and a notification using a horn or the like may be performed in a case in which the notification form using the horn or the like is selected.

### [Process Flow]

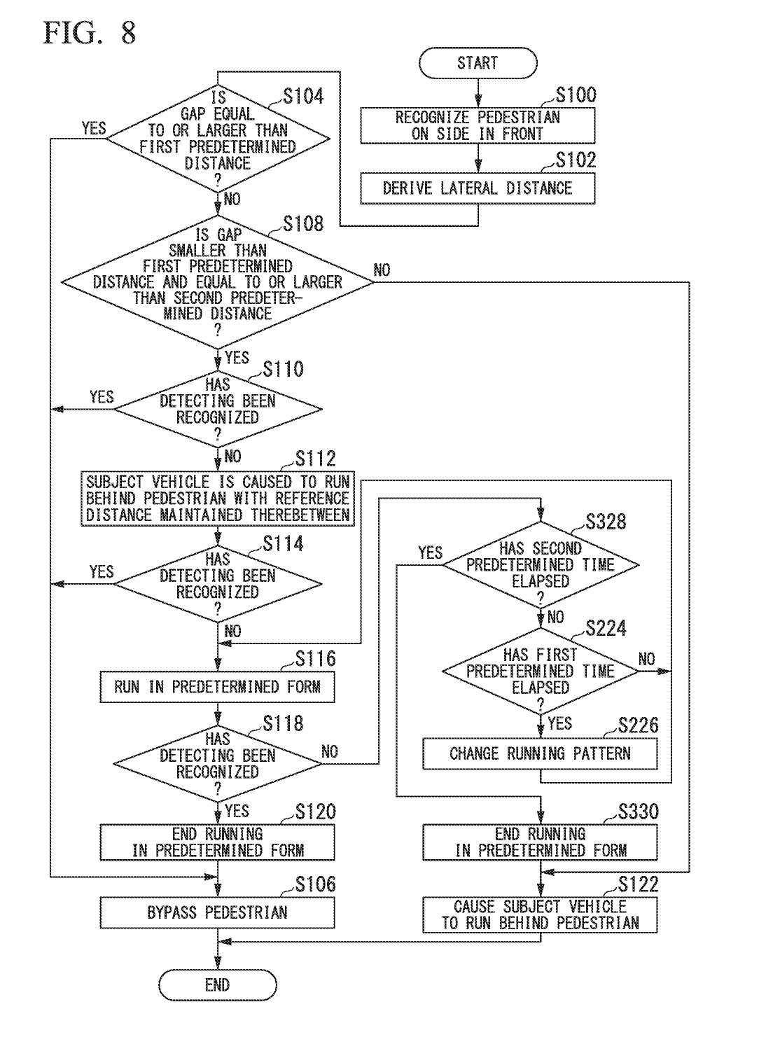

FIG. 8 is a flowchart illustrating the flow of a process executed by the automated driving control device 100 according to third embodiment. Hereinafter, one example of the flow of a process in a case in which the second predetermined time that is an upper limit time of running in the predetermined form is set will be described with reference to FIG. 8.

In the flowchart illustrated in FIG. 8, compared to the flowchart illustrated in FIG. 7, processes of Steps S328 and S330 are added. Thus, hereinafter, mainly, the processes of Steps S328 and S330 will be focused in description.

In the process of Step S118, in a case in which it is not determined by the traffic participant monitoring unit 134 that the pedestrian P1 is aware of the subject vehicle M, the traffic participant correspondence control unit 142, after starting to run in the predetermined form, determines whether or not the second predetermined time has elapsed (Step S328). In a case in which it is not determined that the second predetermined time has elapsed after starting running in the predetermined form, the traffic participant correspondence control unit 142 causes the process to proceed to Step S224.

In a case in which it is determined that the second predetermined time has elapsed after starting running in the predetermined form in the process of Step S328, the traffic participant correspondence control unit 142 ends the running in the predetermined form (Step S330) and causes the process to proceed to Step S122. In this way, the process of this flowchart ends.

As described above, according to the vehicle system 1 of the third embodiment, in addition to effects similar to those according to the second embodiment, in a case in which the second predetermined time has elapsed after causing the subject vehicle M to start to run in the predetermined form, by causing the subject vehicle M to end running in the predetermined form, in a case in which there is a low possibility of the pedestrian P1 being aware of the subject vehicle M even when the running in the predetermined form is continued, it can be configured that a surplus of the energy of the driving source in the subject vehicle M is not used.

In the embodiment described above, in accordance with the running in the predetermined form, for example, a headlight and a hazard lamp of the subject vehicle M may be turned on and off. When the running pattern in the predetermined form is changed, timings at which the headlight and the hazard lamp are turned on and off may be changed altogether.

In the embodiment described above, whether or not the first predetermined time and the second predetermined time are set and the setting of lengths of the first predetermined time and the second predetermined time may be changed and may be performed by the driver.

In the running in the predetermined form, a gap between the subject vehicle M and the pedestrian P1 may be initially set to the first shortest distance D1min and then may be changed to the first longest distance D1max or, contrary to this, the gap may be initially set to the first longest distance D1max and then may be changed to the first shortest distance D1min.

In the embodiment described above, although an example in which the subject vehicle M is steered only in the forward/backward direction has been illustrated as one example of the predetermined form, in a case in which the road width W of the road R1 is sufficiently large, a form in which the subject vehicle M is caused to run along a locus meandering to left and right sides may be employed.

When the traffic participant correspondence control unit 142 causes the subject vehicle M to start to run in the predetermined form, change the running pattern, or end the running in the predetermined form, it is preferable that a vehicle occupant of the subject vehicle M be notified thereof in advance. The traffic participant correspondence control unit 142, for example, may instruct the HMI 30 to output indications of start, change, and end of the running in the predetermined form.

In the embodiment described above, although a case in which the subject vehicle M runs on a narrow road has been described as an assumed view, for example, the case of a facing passage road having one lane in each direction without having any median strip may be included in the assumed view. In a case in which a traffic participant is present, for example, near the center (a position over two lanes) of a facing passage road, unless the traffic participant is aware of and avoids the subject vehicle M, it is assumed to be difficult for the subject vehicle M to change lanes and catch up with the traffic participant or to overtake the traffic participant without changing lanes. Accordingly, the case as described above may be an assumed view.

### [Hardware Configuration]

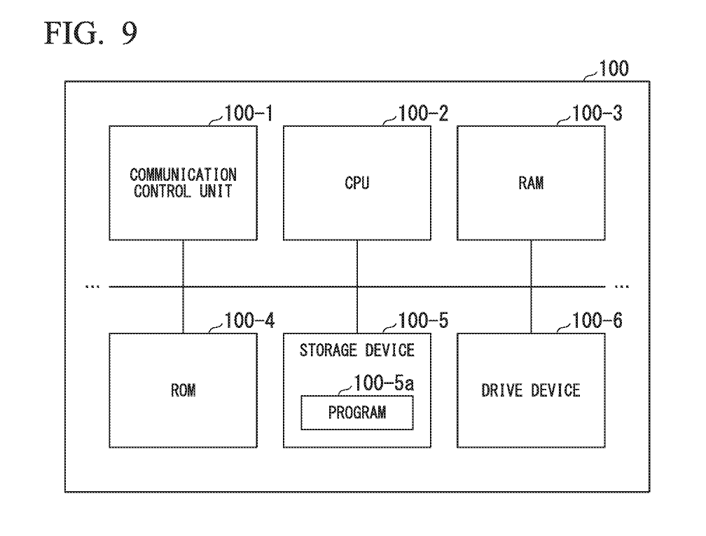

FIG. 9 is a diagram showing one example of the hardware configuration of the automated driving control device 100 according to an embodiment. As shown in the drawing, the automated driving control device 100 has a configuration in which a communication controller 100-1, a CPU 100-2, a random access memory (RAM) 100-3 used as a working memory, a read only memory (ROM) 100-4 storing a boot program and the like, a storage device 100-5 such as a flash memory or an hard disk drive (HDD), a drive device 100-6, and the like are interconnected through an internal bus or a dedicated communication line. The communication controller 100-1 communicates with constituent elements other than the automated driving control device 100. A program 100-5a executed by the CPU 100-2 is stored in the storage device 100-5. This program is expanded into the RAM 100-3 by a direct memory access (DMA) controller (not shown in the drawing) or the like and is executed by the CPU 100-2. In this way, some or all of the first control unit 120 and the second control unit 160 of the automated driving control device 100 are realized.

The embodiment described above can be represented as below. A vehicle control device including a storage device storing a program and a hardware processor and configured such that the hardware processor, by executing the program stored in the storage device, recognizes a peripheral situation of a vehicle, automatically controls acceleration/deceleration and steering of the vehicle on the basis of the recognized peripheral situation, determines whether or not the traffic participant present in the advancement direction of the vehicle is aware of the presence of the vehicle in a case in which a traffic participant is recognized in an advancement direction of the vehicle, and automatically controls steering of the vehicle such that the vehicle is caused to run behind a traffic participant in a case in which the traffic participant advancing in the same direction as that of the vehicle is recognized in the advancement direction of the vehicle, and it is determined by the recognition unit that the traffic participant is not aware of the presence of the vehicle, and the vehicle is caused to run in a predetermined form in a case in which a period of the running behind the pedestrian becomes equal to or longer than a reference.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognition unit that is configured to recognize a peripheral situation of a vehicle; and
a driving control unit that is configured to perform control of acceleration/deceleration and steering of the vehicle on the basis of the peripheral situation recognized by the recognition unit,
wherein the recognition unit determines whether or not a traffic participant present in an advancement direction of the vehicle is aware of the presence of the vehicle, and
wherein, in a case in which the traffic participant advancing in the same direction as that of the vehicle is recognized by the recognition unit, and it is determined by the recognition unit that the traffic participant is not aware of the presence of the vehicle, the driving control unit causes the vehicle to run behind the traffic participant and, in a case in which a period of running behind the traffic participant becomes equal to or longer than a reference, causes the vehicle to run in a predetermined form.

2. The vehicle control device according to claim 1, wherein the predetermined form is a mode of repeatedly increasing and decreasing a distance between the vehicle and the traffic participant.

3. The vehicle control device according to claim 2, wherein, in a case in which it is not determined by the recognition unit that the traffic participant is aware of the presence of the vehicle even after elapse of a first predetermined time, the driving control unit shortens a period at which the distance between the vehicle and the traffic participant is increased and decreased.

4. The vehicle control device according to claim 3, wherein the driving control unit increases a shortest distance between the vehicle and the traffic participant as the period at which the distance between the vehicle and the traffic participant is increased and decreased is further shortened.

5. The vehicle control device according to claim 1, wherein the driving control unit causes the vehicle to run while avoiding contact with the traffic participant in a case in which a distance between the traffic participant and an end part of a road on a side opposite to the traffic participant in a width direction of the road with the vehicle interposed therebetween is equal to or longer than a first predetermined distance, causes the vehicle to run behind the traffic participant in a case in which the distance is shorter than the first predetermined distance and is equal to or longer than a second predetermined distance, and causes the vehicle to run in a predetermined form in a case in which a period of running behind the traffic participant becomes equal to or longer than a reference.

6. The vehicle control device according to claim 1, wherein, in a case in which the vehicle is caused to run in the predetermined form, once it is determined by the recognition unit that the traffic participant is aware of the presence of the vehicle, the driving control unit causes the vehicle to end the running in the predetermined form.

7. The vehicle control device according to claim 5,
wherein the recognition unit also recognizes the distance while the vehicle is caused to run in the predetermined form by the driving control unit, and
wherein, in a case in which the vehicle is caused to run in the predetermined form, once it is determined by the recognition unit that the distance is equal to or longer than the first predetermined distance, the driving control unit causes the vehicle to end the running in the predetermined form.

8. The vehicle control device according to claim 1, wherein, in a case in which a second predetermined time, which is longer than a first predetermined time, elapses after the vehicle is caused to start running in the predetermined form, the driving control unit causes the vehicle to end the running in the predetermined form.

9. A vehicle control method using a vehicle control device, the vehicle control method comprising:
recognizing a peripheral situation of a vehicle;
automatically controlling acceleration/deceleration and steering of the vehicle on the basis of the recognized peripheral situation;
determining whether or not a traffic participant present in an advancement direction of the vehicle is aware of the presence of the vehicle; and
automatically controlling steering of the vehicle such that the vehicle is caused to run behind a traffic participant in a case in which the traffic participant advancing in the same direction as that of the vehicle is recognized in the advancement direction of the vehicle, and it is determined that the traffic participant is not aware of the presence of the vehicle, and the vehicle is caused to run in a predetermined form in a case in which a period of running behind the traffic participant becomes equal to or longer than a reference.

10. A non-transitory computer-readable storage medium having a program stored thereon, causing a vehicle control device to execute:
recognizing a peripheral situation of a vehicle;
automatically controlling acceleration/deceleration and steering of the vehicle on the basis of the recognized peripheral situation;
determining whether or not a traffic participant present in an advancement direction of the vehicle is aware of the presence of the vehicle; and
automatically controlling steering of the vehicle such that the vehicle is caused to run behind a traffic participant in a case in which the traffic participant advancing in the same direction as that of the vehicle is recognized in the advancement direction of the vehicle, and it is determined that the traffic participant is not aware of the presence of the vehicle, and the vehicle is caused to run in a predetermined form in a case in which a period of running behind the traffic participant becomes equal to or longer than a reference.
